(19) United States
(12) Patent Application Publication
(10) Pub. No.: US 2026/0104601 A1
(43) Pub. Date: Apr. 16, 2026

(54) Solar Eclipse Glasses

(71) Applicant: Robert T. Carr, Toronto (CA)

(72) Inventor: Robert T. Carr, Toronto (CA)

(21) Appl. No.: 19/235,169

(22) Filed: Jun. 11, 2025

Related U.S. Application Data
(60) Provisional application No. 63/658,625, filed on Jun. 11, 2024.

(51) Int. Cl. G02C 11/00; G02C 5/00; G02C 5/04; G02C 7/10; G02C 11/08

(52) U.S. Cl. CPC G02C 11/12; G02C 5/008; G02C 5/045; G02C 7/10; G02C 11/08

(57) ABSTRACT

An apparatus for safely viewing a solar eclipse is provided. The apparatus comprises a durable frame made from materials such as titanium or tungsten, ensuring longevity for reuse across multiple eclipse events. The frame includes left and right lens assemblies connected by an adjustable nose bridge. An adjustment mechanism, such as a rack and pinion system controlled by a screw knob, allows for the lateral adjustment of the lens assemblies to provide a custom fit for any user. Extremely dark tinted lenses, compliant with the ISO 12312-2 safety standard, are secured in the lens assemblies to protect the wearer's eyes. The apparatus further includes side shields to block peripheral light and a padded interior surface for enhanced comfort and a light-tight seal against the wearer's face.

### BACKGROUND OF THE INVENTION

The present invention relates to eyeglasses designed for viewing a solar eclipse. The present invention provides a pair of adjustable, durable glasses that protect the wearer's eyes from damage while allowing them to safely observe a solar eclipse.

Solar eclipses occur when the Moon passes between Earth and the Sun, which either totally or partially obscures the view of the Sun from a small part of Earth. This rare visual spectacle has fascinated humans for centuries. However, directly viewing a solar eclipse without proper eye protection can cause severe and permanent eye damage, including solar retinopathy. The intense visible light from the sun can damage the eye's sensitive retina, often without causing any immediate pain. Furthermore, the sun emits harmful ultraviolet (UV) and infrared (IR) radiation which are invisible to the human eye but can cause long-term damage, including cataracts and other ocular conditions.

Typical sunglasses are not sufficiently tinted to protect the wearer from these harmful effects. Recognizing this danger, specialized solar eclipse glasses have been developed. To be considered safe, these glasses must meet specific international safety standards, such as ISO 12312-2. This standard dictates the specific transmittance requirements for solar filters, ensuring that they reduce visible sunlight to a safe and comfortable level while also blocking harmful levels of UV and IR radiation.

The most common type of glasses that meet this standard are typically made from cardboard and other flimsy, paper-like materials. These glasses are mass-produced in a single size, meaning they often do not fit the wearer properly or comfortably. An improper fit can create gaps between the wearer's face and the glasses. This is a critical flaw, as stray light entering from the periphery can still pose a risk and cause discomfort. For full protection, the viewing device must provide adequate coverage, blocking light from entering from the sides of the eyes. This side coverage, as illustrated in the side shields of FIG. 3 in the present invention, is only effective if the glasses fit snugly against the face. If the frame is too wide or sits incorrectly, these protective features are rendered less effective, leaving the wearer vulnerable.

Furthermore, these single-use paper glasses are not durable. They are easily damaged, creased, or torn, often rendering them unusable. This fragility creates waste and requires individuals to acquire a new pair for each solar eclipse event. The high demand for these glasses immediately before an eclipse can also make them difficult to obtain. Therefore, there is a need for a viewing apparatus that not only utilizes lenses meeting the ISO 12312-2 standard but also provides a durable, reusable, and adjustable frame. Such a device would allow a user to achieve a customized and secure fit, ensuring that protective elements like side shields are properly positioned to eliminate gaps and provide comprehensive protection from all angles.

In light of the devices disclosed in the known art, it is submitted that the present invention substantially diverges in design elements and methods from the known art and consequently it is clear that there is a need in the art for an improvement of a reliable and long-lasting protection for all future solar eclipses, eliminating the waste and inconvenience of disposable paper glasses. In this regard the instant invention substantially fulfills these needs.

### SUMMARY OF THE INVENTION

In view of the foregoing disadvantages inherent in the known solar eclipse glasses now present in the art, the present invention provides a new and improved solar eclipse glasses construction wherein the same can be utilized for providing safe, durable, and reusable protection for viewing a solar eclipse. The glasses feature a robust frame and high-quality lenses that meet international safety standards, offering a superior alternative to disposable paper glasses.

It is an objective of the present invention to provide solar eclipse glasses constructed from durable materials, such as titanium or tungsten, allowing the glasses to be reused for many future solar eclipses.

It is another objective of the present invention to provide solar eclipse glasses that are adjustable to comfortably and securely fit any user. The invention includes a novel adjustment mechanism, such as a rack and pinion system, to precisely control the width of the frame.

It is yet another objective of the present invention to provide solar eclipse glasses with lenses that offer exceptional protection, equivalent to the strength and darkness of a welder's lens and certified to the ISO 12312-2 international safety standard.

It is a further objective of the present invention to provide solar eclipse glasses with side shields to block peripheral light and padded surfaces for enhanced comfort and a light-tight seal against the wearer's face.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a front elevation view of one embodiment of the solar eclipse glasses in a contracted configuration.

FIG. 2 shows a front elevation view of the solar eclipse glasses of FIG. 1 in an expanded configuration.

FIG. 3 shows a side elevation view of one embodiment of the solar eclipse glasses.

FIG. 4 shows a top plan view of one embodiment of the solar eclipse glasses.

### DETAILED DESCRIPTION OF THE INVENTION

Reference is made herein to the attached drawings. Like reference numerals are used throughout the drawings to depict like or similar elements of the deployable buoyancy system. For the purpose of presenting a clear description of the present invention, the preferred embodiment will be discussed in relation to providing flotation and stability to a vehicle in water environments. The figures are intended for representative purposes only and should not be considered limiting in any respect.

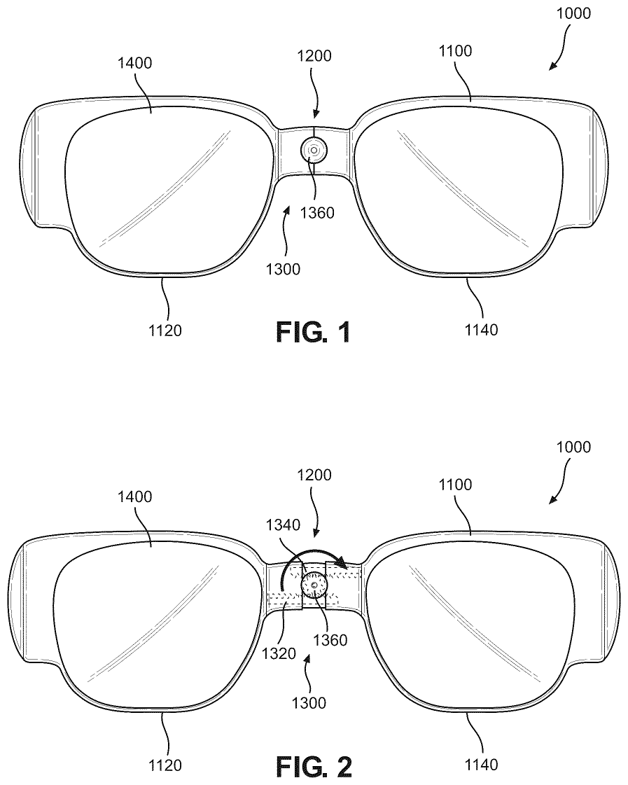

Referring now to FIG. 1 and FIG. 2, front elevation views of one embodiment of the solar eclipse glasses are shown in a contracted and an expanded configuration, respectively. The solar eclipse glasses 1000 comprise a frame 1100 which includes a left lens assembly 1120 and a right lens assembly 1140. The left and right lens assemblies 1120, 1140 are connected by a nose bridge assembly 1200. Each lens assembly houses a tinted lens 1400.

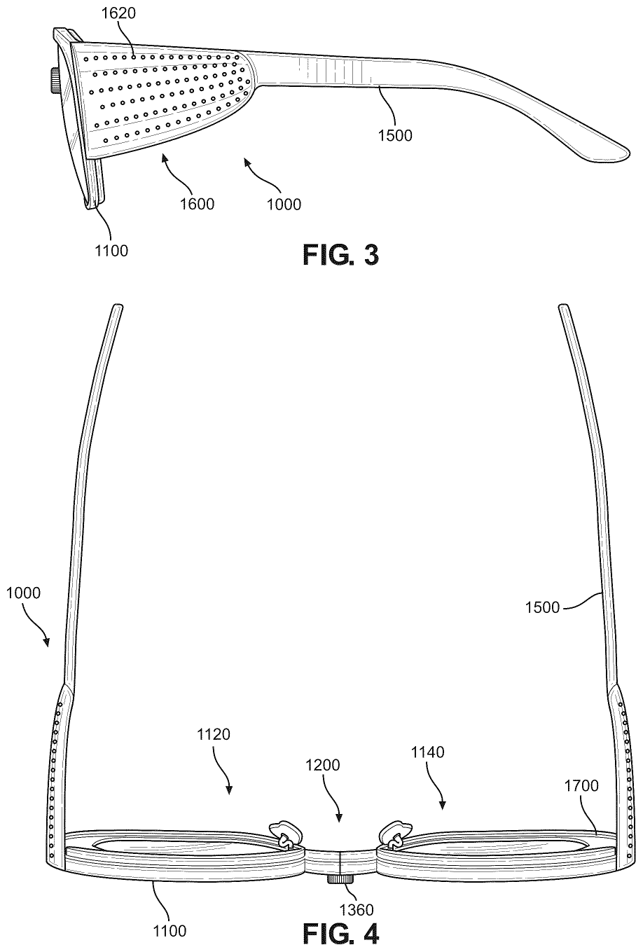

In one embodiment, the frame 1100 and associated arms 1500, shown in FIG. 3, are composed of a strong, durable material such as titanium or tungsten. The frame 1100 composition provide longevity and reusability of the glasses 1000. The tinted lenses 1400 are secured within each lens assembly 1120, 1140. These lenses 1400 are of an extremely dark tint sufficient to protect the wearer's eyes from harmful solar radiation during an eclipse. In a preferred embodiment, the lenses 1400 provide a level of darkness and protection equivalent to that of a welder's lens and meet the ISO 12312-2 international safety standard.

An adjustment mechanism 1300 allows the distance between the left lens assembly 1120 and the right lens assembly 1140 to be modified. The adjustment mechanism 1300 is configured to adjust the overall width of the frame 1100 to ensure a proper fit for any user. In the illustrated embodiment, the adjustment mechanism 1300 is a rack and pinion system integrated into the nose bridge assembly 1200. The nose bridge assembly 1200 may be telescopic to accommodate the movement of the lens assemblies.

As shown in FIG. 2, the rack and pinion system includes a rack 1320, or a pair of racks, associated with one or both lens assemblies and a pinion gear 1340 controlled by a screw adjustment knob 1360. The screw adjustment knob 1360 is generally centered on the nose bridge assembly 1200 and is accessible from a front side of the apparatus. When a user turns the screw adjustment knob 1360 in a first direction, the pinion gear 1340 rotates, engaging the rack 1320 and causing the left lens assembly 1120 and the right lens assembly 1140 to move laterally apart, transitioning the frame 1100 to an expanded configuration (FIG. 2). Rotating the screw adjustment knob 1360 in an opposing second direction causes the lens assemblies to move closer together, transitioning the frame 1100 to a contracted configuration (FIG. 1). In another embodiment, the adjustment mechanism 1300 could comprise a threaded rod having opposing threads on each end, wherein rotation of a central adjustment knob draws the lens assemblies together or pushes them apart.

Referring now to FIG. 3, a side elevation view of the solar eclipse glasses 1000 is shown. A foldable arm 1500 is attached to the frame 1100. Between the arm 1500 and the lens assembly, a side shield 1600 is positioned. The side shield 1600 is configured to provide complete protection by blocking peripheral light that standard eyeglass frames would otherwise allow in. In the shown embodiment, the side shield 1600 extends rearward from the frame 1100 and wraps around the temporal region of the user's face. The effectiveness of the side shield 1600 is directly enhanced by the adjustability of the frame 1100. By adjusting the width of the glasses via the adjustment mechanism 1300, the user can ensure the side shields 1600 sit snugly against their face, eliminating any gaps through which harmful stray light could enter. In one embodiment, the side shield 1600 may also include small ventilation holes 1620 to allow for airflow, preventing fogging and increasing comfort during extended wear without compromising its light-blocking capability.

Referring now to FIG. 4, a top plan view of the solar eclipse glasses 1000 is shown. This view further illustrates the relationship between the lens assemblies 1120, 1140, the nose bridge assembly 1200 with its adjustment knob 1360, and the arms 1500. The interior surfaces of the frame 1100 that contact the wearer's face may be lined with a soft padding 1700. This padding 1700 ensures a comfortable, flush fit against the skin, creating a light-tight seal to prevent any unfiltered light from reaching the user's eyes. The padding also helps to manage sweat and prevent skin irritation.

In operation, a user first adjusts the width of the frame 1100 by turning the adjustment knob 1360 until the glasses 1000 fit comfortably and securely. This custom fit ensures the side shields 1600 and padding 1700 form an effective seal. The combination of the lightweight yet durable frame, custom fit, and comfortable padding provides a user experience akin to wearing a high-quality pair of regular glasses. The user can then wear the glasses 1000 to safely view a solar eclipse, with the confidence that their eyes are fully protected. Due to their durable construction, the glasses can be safely stored and reused for all future eclipse events.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A solar eclipse glasses, comprising:
a frame comprising a left lens assembly and a right lens assembly;
a pair of foldable arms, wherein one arm is attached to an outer side of the left lens assembly and the other arm is attached to an outer side of the right lens assembly;
a nose bridge assembly positioned between and connecting the left lens assembly and the right lens assembly;
a tinted lens secured within each of the left and right lens assemblies;
an adjustment mechanism integrated with the nose bridge assembly, the adjustment mechanism configured to controllably adjust a lateral distance between the left lens assembly and the right lens assembly to either narrow or widen the frame;
a pair of side shields, wherein one side shield is positioned adjacent to the left lens assembly and the other side shield is positioned adjacent to the right lens assembly, each side shield configured to block peripheral light.

2. The apparatus of claim 1, wherein the frame and the pair of foldable arms are composed of a material selected from the group consisting of titanium and tungsten.

3. The apparatus of claim 1, wherein the adjustment mechanism comprises a rack and pinion system.

4. The apparatus of claim 3, wherein the rack and pinion system comprises a screw adjustment knob accessible from a front side of the nose bridge assembly, a pinion gear coupled to the screw adjustment knob, and at least one rack engaged by the pinion gear, whereby rotation of the screw adjustment knob causes lateral movement of the left and right lens assemblies.

5. The apparatus of claim 4, wherein rotation of the screw adjustment knob in a first direction transitions the frame to an expanded configuration, and rotation in an opposing second direction transitions the frame to a contracted configuration.

6. The apparatus of claim 1, wherein the nose bridge assembly is telescopic to accommodate changes in the lateral distance between the left and right lens assemblies.

7. The apparatus of claim 1, wherein each tinted lens conforms to an ISO 12312-2 safety standard.

8. The apparatus of claim 1, wherein each side shield includes a plurality of ventilation openings.

9. The apparatus of claim 1, further comprising a padded material disposed on an interior surface of the left and right lens assemblies, such that the padded material is configured to maintain flush contact with a wearer's face.
